(19) United States
(12) Patent Application Publication
(10) Pub. No.: US 2009/0240660 A1
(43) Pub. Date: Sep. 24, 2009

(54) INTEGRATION FOR INTELLIGENCE DATA SYSTEMS

(76) Inventors: Christopher B. Morgan, Stafford, VA (US); Tracy C. Morgan, Stafford, VA (US); Eric R. White, Fredericksburg, VA (US); John C. Moore, Woodbridge, VA (US); Danny R. Jessee, JR., Ruther Glen, VA (US); Matthew Ingerman, Fredericksburg, VA (US)

Correspondence Address: HOLLAND & KNIGHT LLP, 10 ST. JAMES AVENUE, BOSTON, MA, 02116-3889, US

(21) Appl. No.: 12/053,274

(22) Filed: Mar. 21, 2008

Related U.S. Application Data
(60) Provisional application No. 61/037,538, filed on Mar. 18, 2008.

(51) Int. Cl. G06F 17/30

(52) U.S. Cl. 707/3; 707/E17.014; 707/E17.061; 707/E17.032

(57) ABSTRACT

A system includes one or more server computing devices coupled to a data network. One or more storage devices are associated with each of the one or more server computing devices. A search device is configured to search intelligence data residing on one or more of the storage devices.

### CROSS-REFERENCE TO RELATED APPLICATIONS

This application claims the benefit of U.S. provisional patent application Ser. No. 61/037,538, filed on Mar. 18, 2008, the entire disclosure of which is incorporated herein by reference.

### TECHNICAL FIELD

The present disclosure relates to intelligences data systems, and more particularly relates to the integration and interoperability of intelligence data systems.

### BACKGROUND

While an enormous quantity of intelligence information is collected by various intelligence agencies and organizations, such as the Central Intelligence Agency (CIA), Marine Corps Intelligence Activity, National Security Agency, and the like, the collected intelligence information is typically stored in databases managed by the individual agencies and organizations. As such, a member of a first organization may not be able to access, and may, therefore never know about, information collected by another organization, which may be potentially useful and valuable to the member of the first organization. Sharing information amongst agencies present a number of obstacles, including different data storage structures, searching a multitude of different and geographically divers databases, as well as security concern.

### SUMMARY

According to a first implementation, a system includes one or more server computing devices coupled to a data network. One or more storage devices are associated with each of the one or more server computing devices. The system further includes a search device configured to search intelligence data residing on one or more of the storage devices.

One or more of the following features may be included. The search device may be configured to index at least a portion of the intelligence data residing on one or more of the storage devices. The intelligence data may include unstructured intelligence data. The intelligence data may include structured intelligence data. The structured intelligence data may reside in one or more intelligence databases on one or more of the storage devices.

The intelligence data may include metadata associated with one or more intelligence documents. The metadata associated with one or more intelligence documents may reside in a metadata catalog stored on one or more of the storage devices.

The system may include a content management system for creating a document library. At least a portion of the intelligence data residing on the one or more storage devices may be included within the document library.

According to another implementation, a system may include a first server computing device coupled to a first data network. The first server computing device includes one or more storage devices including intelligence data. A first node platform is coupled to the first data network and coupled to a second data network. The first node platform includes a first search device configured to search the intelligence data residing on one or more of the storage devices.

One or more of the following features may be included. The first search device may be configured to index at least a portion of the intelligence data of the first server computing device. The intelligence data of the first server computing device may include unstructured data. The intelligence data of the first server computing device may include structured data. The structured data may reside in a database on the one or more storage devices.

The system may further include a second node platform coupled to the second data network. The second node platform may include a second search device configured to search the intelligence data of the first server computing device. The second search device may be configured to search an index of the intelligence data created by the first search device. The second search device may be configured to search a metadata catalog including metadata associated with the intelligence data. The metadata catalog may be associated with the first node.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a data network including a plurality of nodes connected to intelligence data systems;

FIG. 2 is a flow chart of a process for accessing intelligence data from one or more of the intelligence data systems of FIG. 1;

FIG. 3 diagrammatically depicts a search interface for searching intelligence data residing in one or more of the intelligence data systems of FIG. 1;

FIG. 4 diagrammatically depicts a search interface for searching intelligence data residing in one or more of the intelligence data systems of FIG. 1;

FIG. 5 is a flow chart of a process for creating a document library and generating metadata associated with intelligence data in one or more of the intelligence data systems of FIG. 1;

FIG. 6 diagrammatically depicts a piece of intelligence data for which metadata may be generated and associated.

FIG. 7 is a flow chart of a process for accessing intelligence data relative to geospatial information; and

FIG. 8 diagrammatically depicts a user interface for accessing intelligence data relative to geospatial information.

### DETAILED DESCRIPTION OF PREFERRED EMBODIMENTS

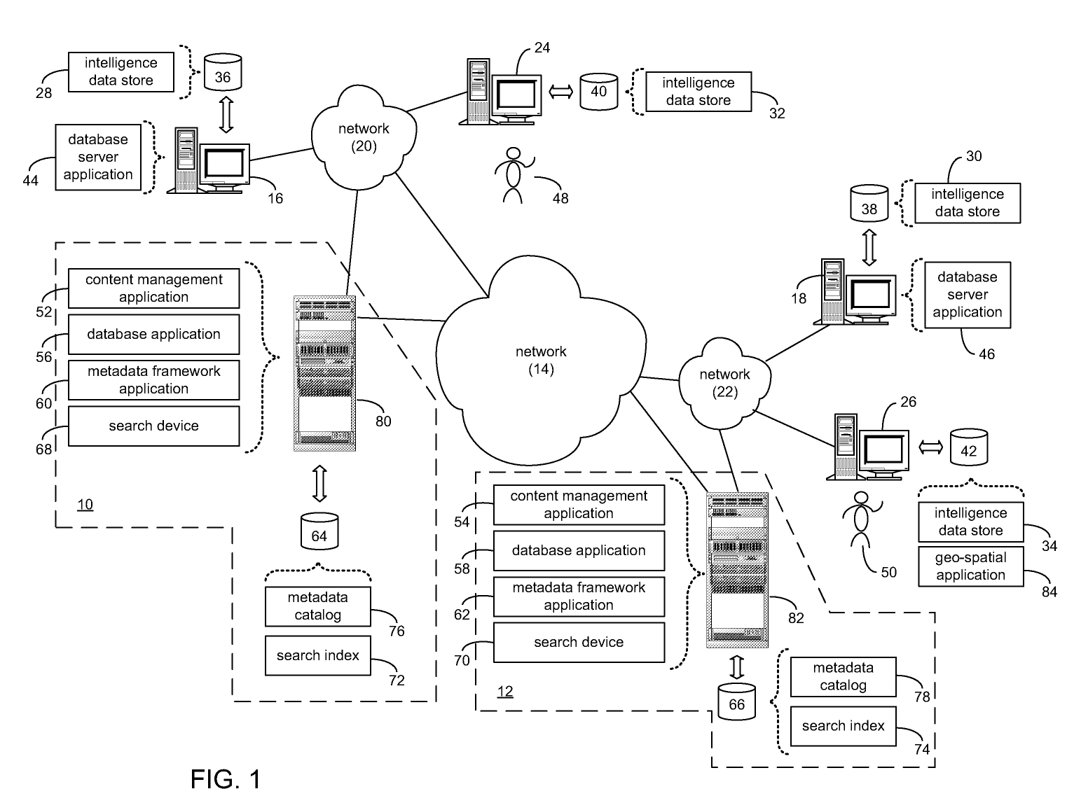

Referring to FIG. 1, there is shown a federated intelligence network including a plurality of nodes (e.g., nodes 10, 12) coupled to data network 14. Data network 14 may include, but is not limited to, for example, the Internet, a local area network (LAN), a wide area network (WAN), or other data network. One or more server computing devices (e.g., server computers 16, 18) may be associated with respective nodes 10, 12. Server computers 16, 18 may be directly coupled to respective nodes 10, 12 and/or may be coupled to respective nodes 10, 12 through one or more secondary data networks (e.g., data networks 20, 22, respectively). Secondary data networks 20, 22 may include, but are not limited to, for example, a local area network (LAN), wide area network (WAN), or other similar data network. Additionally, one or more user computing devices (e.g., computing devices 24, 26) may be associated with respective nodes 10, 12 (e.g., via secondary data networks 20, 22, respectively).

While only two nodes (i.e., nodes 10, 12) are shown, this is for illustrative purposes only, as any number of nodes may be included in the federated intelligence network. Similarly while only a single server computer (i.e., server computers 16, 18) are shown associated with each of nodes 10, 12, this is also only for illustrative purposes, as any number of server computers may be associated with each node. Further, while only a single user computing device (e.g., computing devices 24, 26) are shown associated with each of nodes 10, 12, this is for illustrative purposes only, as any number of user computing devices may be associated with each node.

Nodes 10, 12 may each run a network operating system, examples of which may include, but are not limited to, Microsoft Windows XP Server™, Novell Netware™, or Redhat Linux™, for example. Additionally, nodes 10, 12 may each execute a web server application, examples of which may include, but are not limited to, Microsoft IIS™, Novell Webserver™, or Apache Webserver™, that allows for HTTP (i.e., HyperText Transfer Protocol) access to nodes 10, 12 via network 14 and/or via respective secondary networks 20, 22.

Similarly, server computers 16, 18 may each run a network operating system, examples of which may include, but are not limited to, Microsoft Windows XP Server™, Novell Netware™, or Redhat Linux™, for example. Additionally, server computer 16, 18 may each execute a web server application, examples of which may include, but are not limited to, Microsoft IS™, Novell Webserver™, or Apache Webserver™, that allows for HTTP (i.e., HyperText Transfer Protocol) access to server computers 16, 18 via secondary networks 20, 22, respectively (e.g., an via network 14 through respective secondary networks 20, 22).

Computing devices 24, 26 may each execute an operating system, examples of which may include, but are not limited to, Microsoft Windows™, Redhat Linux™, or a custom operating system.

Server computers 16, 18 and computing devices 24, 26 may each include an intelligence data store (e.g., intelligence data stores 28, 30, 32, 34, respectively), e.g., stored on storage devices 36, 38, 40, 42, respectively. Storage devices 36, 38, 40, 42 may include, but are not limited to, hard disk drives, tape drives, optical drives, random array of redundant disk (RAID) arrays, random access memories (RAM), read only memories (ROM), solid state memory devices (e.g., solid state hard drives, secure digital (SD) storage devices, compact flash (CF) storage devices, and the like), for example.

Intelligence data stores 28, 30, 32, 34 may include unstructured and/or structured data. Unstructured data may include any data that is not parsed into specified fields. Examples of unstructured data may include, but are not limited to, data shares, desktop files, email files, instant messaging files, and the like. Structured data may include, e.g., information in a relational database management system. For example, server computers 16, 18 may execute database server applications 44, 46 that may manage intelligence databases (e.g., stored on storage devices 36, 38) included within intelligence data stores 28, 30. In addition to structured intelligence data residing in the intelligence databases, intelligence data stores 28, 30 associated with server computers 16, 18, may include unstructured intelligence data.

In one aspect, intelligence data stores 28, 30, 32, 34 may include data stores associated with an intelligence gathering and/or analyzing organization, such as the Central Intelligence Agency, the National Security Agency, Marine Corps Intelligence Activity, or the like. Intelligence data (i.e., content) residing in data stores 28, 30, 32, 34 may include, but is not limited to, for example, intelligence documents, presentations, flight plans, imagery data, event data, etc.

Examples of database server applications 44, 46 may include, but are not limited to, Oracle Enterprise Server™ 10 g. The instruction sets and subroutines of database server application 44, 46, which may be stored on storage devices 36, 38 (respectively), coupled to server computers 16, 18, may be executed by one or more processors (not shown) and one or more memory architectures (not shown) incorporated into server computers 16, 18.

Nodes 10, 12 may, at least in part, control the storing of content (i.e., intelligence data) in intelligence data stores 28, 32 and 30, 34 respectively. Additionally, nodes 10, 12 may control the retrieval of content from intelligence data stores 28, 30, 32, 34. For example, via nodes 10, 12, one or more users (e.g., users 48, 50) may store data in one or more of intelligence data stores 28, 30, 32, 34. Additionally, via nodes 10, 12 users 48, 50 may retrieve content from one or more of intelligence data stores 28, 30, 32, 34.

Nodes 10, 12 may each execute a content management application (e.g., content management applications 52, 54), a database server application (e.g., database applications 56, 58), and a metadata framework application (e.g., metadata framework applications 60, 62). One or more of content management applications 52, 54, database applications 56, 58, and metadata framework applications 60, 62 may include software components, hardware components, and/or combinations of software and hardware components.

The instruction sets and subroutines of content management applications 52, 54, database applications 56, 58, and metadata framework applications 60, 62, which may be stored on one or more storage devices (e.g., storage devices 64, 66) coupled to each of nodes 10, 12, may be executed by one or more processors (not shown) and one or more memory architectures (not shown) incorporated into nodes 10, 12. Storage devices 64, 66 may include, but are not limited to, hard disk drives, tape drives, optical drives, random array of redundant disk (RAID) arrays, random access memories (RAM), read only memories (ROM), solid state memory devices (e.g., solid state hard drives, secure digital (SD) storage devices, compact flash (CF) storage devices, and the like), for example.

Content management applications 52, 54 may include, for example, Microsoft SharePoint Server™, which may allow one or more of users 48, 50 to enter intelligence data into one or more of intelligence data stores 28, 30, 32, 34. Via content management applications 52, 54 one or more of users 48, 50 may create, modify, and/or delete intelligence data residing in one or more of intelligence data stores 28, 30, 32, 34. For example content management applications 52, 54 may create a document library (e.g., residing in one or more of intelligence data stores 28, 30, 32, 34). At least a portion of the intelligence data residing on one or more of storage devices 36, 38, 40, 42 may be included within the document library. Additionally, content management applications 52, 54 may provide a portal, e.g., through which a user on a respective network (e.g., user 48 on network 20 and user 50 on network 22) may access respective nodes 10, 12.

Additionally, nodes 10, 12 may include one or more search devices (e.g., search devices 68, 70). Search devices 68, 70, may include hardware devices, software devices, and/or combination hardware/software devices configured to search intelligence data residing in one or more intelligence data stores 28, 30, 32, 34 (e.g., residing on storage devices 36, 38, 40, 42). According to one example, search devices 68, 70 may each include a Google Search Appliance™.

Search devices 68, 70 may use one or more of keyword searches, metadata searches, database search queries (e.g., using structured query language, SQL), or other known searching methodologies to search one or more of intelligence data stores 28, 30, 32, 34. Additionally, one or more of search devices 68, 70, may be configured to crawl (e.g., using crawl patterns defined by an administrator or other user) intelligence data stores 28, 30, 32, 34, via various methods, including, but not limited to, HTTP, HTTPS, Server message Block (SMB), and Universal Naming Convention (UNC). Information collected via various searching methodologies may be stored in an index (e.g., search indexes 72, 74) associated with one or more of search devices 68, 70 (e.g., residing on storage devices 64, 66, or a search device specific storage device). As such, search devices 68, 70 may conduct searches of both structured and unstructured intelligence data residing in one or more of intelligence data stores 28, 30, 32, 34.

In addition to searching one or more of intelligence data stores 28, 30, 32, 34 coupled to a respective local area network (e.g., networks 20, 22), search devices 68, 70 may search remote intelligence data stores. For example, search device 68 may be configured to search and index intelligence data stores 28, 32 coupled to network 20. Additionally, search device 68 may be configured to search intelligence data stores 30, 34, e.g., via network 14 and network 22, using HTTP or similar search methods. Further, search device 68 may search index 74 populated by search device 70. Search index 74 may include an index of intelligence data residing in intelligence data stores 30, 34 associated with network 22, to which search device 70 may be coupled.

Consistent with the foregoing example, a user (e.g., user 48) may utilize search device 68 to search both structured and unstructured intelligence data residing in intelligence data stores 28, 32. Further user 48 may utilize search device 68 to search both structured and unstructured intelligence data residing in intelligence data stores 30, 34 (e.g., via networks 14 and 22). Additionally, user 48 may utilize search device 68 to search index 74 populated by search device 70, coupled to network 22.

Continuing with the above-stated example, user 48 may utilize content management application 52 to create, modify, and delete intelligence data in one or more of intelligence data stores 28, 32. During the creation, modification, and/or deletion of intelligence data, content management application 52 may associate metadata with the intelligence data. For example, content management application 52 may associate metadata with the intelligence data based upon a characteristic of the data (e.g., based upon a file or document type). Further, content management application 52 may prompt user 48 to provide metadata relative to the intelligence data. For example, content management application 52 may prompt user 48 for information such as, intelligence data type, subject matter, security classification, geographic location information, etc. Content management process 52 may use responses from user 48 relative to such prompts to associate metadata with the intelligence data being created, modified, or deleted.

Metadata framework applications 60, 62 may associate additional metadata with the intelligence data. Metadata framework application 60, 62 may provide an application programming interface (API) that allows information to be written to a metadata catalog (MDC) (e.g., metadata catalogs 76, 78) through the use of adapters. For example, for intelligence data (e.g., intelligence documents, flight plans, imagery, event memos, etc.) for which there is a defined XML schema file, metadata framework applications 60, 62 may utilize the XML schema files to generate metadata associated with the intelligence data, e.g., based upon, at least in part, the XML schema files. Metadata framework applications 60, 62 may ingest the metadata associated with the intelligence data into an associated metadata catalog (e.g., metadata catalogs 76, 78, respectively). Database applications 56, 58 may be utilized to ingest the metadata generated by metadata framework applications 60, 62 into respective metadata catalogs 76, 78. Additionally, database applications 56, 58 may allow metadata catalogs 76, 78 to be queried.

As discussed above, search devices 68, 70 may search one or more of intelligence data stores 28, 30, 32, 34. Additionally, search devices 68, 70 may search and index metadata catalogs 76, 78. One or more of users 48, 50 may search intelligence data residing in one or more of intelligence data stores 28, 30, 32, 34 by querying metadata catalogs 76, 78 (e.g., via one or more of database applications 56, 58 associated with nodes 10, 12) and/or using search devices 68, 70. As such, a user (e.g., user 48) connected to a first node (e.g., node 10) may search intelligence data residing in intelligence data stores 28, 32 connected to network 20 as well as intelligence data residing in intelligence data stores 30, 34 connected to network 22. Accordingly, nodes 10, 12 may provide data level interoperability of various intelligence system, which may enable users anywhere on network 14 (or a network coupled to network 14) to search any intelligence data store managed by a node.

While nodes 10, 12 have been depicted as a rack-based server computer (e.g., rack server computers 80, 82) including one or more processors (not shown) and one or more memory architectures (not shown) for executing content management applications 52, 54, database applications, and metadata framework applications 60, 62, as well as including storage devices 64, 66 and hardware aspects of search devices 68, 70, such depiction is for the purpose of illustration and should not be construed as limiting this disclosure. For example, nodes 10, 12 may be implemented as a plurality of discrete computing devices coupled together and/or coupled to one or more of networks 20, 22.

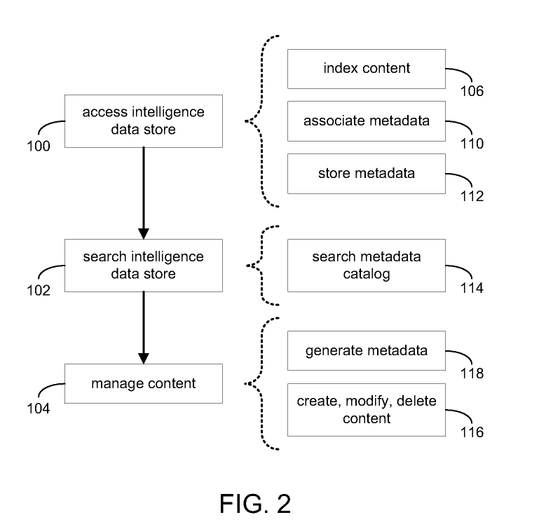

For the purpose of the following discussion, the aspects associated with node 10 and network 20 will be discussed. However, this should not be construed as a limitation on the present disclosure as other implementations may suitable be employed, e.g., including aspects associated with node 12 and network 22 and/or combinations of aspects of nodes 10 and 12 and networks 20 and 22. Referring also to FIG. 2, and continuing with the above-stated example, one or more of metadata framework application 60 and search device 68 may access 100 one or more of intelligence data stores 28, 32 distributed across network 20 (and/or intelligence data stores 30, 34 distributed across network 22). Search device 68 may search 102 one or more of intelligence data stores 28, 32 (and/or intelligence data stores 30, 34). Content management application 52 may manage 104 at least a portion of the content of one or more of intelligence data stores 28, 32 (and/or intelligence data stores 30, 34).

As discussed above, search device 68 may access 100 one or more of intelligence data stores 28, 32 to index 106 at least a portion of the content (e.g., intelligence data) of one or more of intelligence data stores 28, 32. For example, search device 68 may crawl one or more of intelligence data stores 28, 32 and send a request to one or more of data stores 28, 32 and add the returned results to search index 72. At least a portion of one or more of intelligence data stores 28, 32 may include unstructured data, e.g., residing in a document library. Additionally, at least a portion of the content (e.g., intelligence data) of one or more of intelligence data stores 28, 32 may include structured data, e.g., residing in a database included in one or more of intelligence data stores 28, 32.

Accessing 100 the one or more intelligence data stores may include associating 108 metadata with at least a portion of the content of the one or more intelligence data stores. As described above, metadata framework application 60 may provide an application programming interface (API) which may generate metadata for content (e.g., intelligence data) created, modified and/or deleted by users of the system (e.g., user 48). The metadata generated by metadata framework application 60 may be based upon, at least in part, one or more XML schema files corresponding to a given content type (e.g., intelligence data format, such as intelligence documents, flight plans, etc.). Metadata framework application 60 may associate 108 the generated metadata with the content (e.g., intelligence data). The metadata associated 108 with at least a portion of the content of the one or more data stores may be stored 110 in metadata catalog 76.

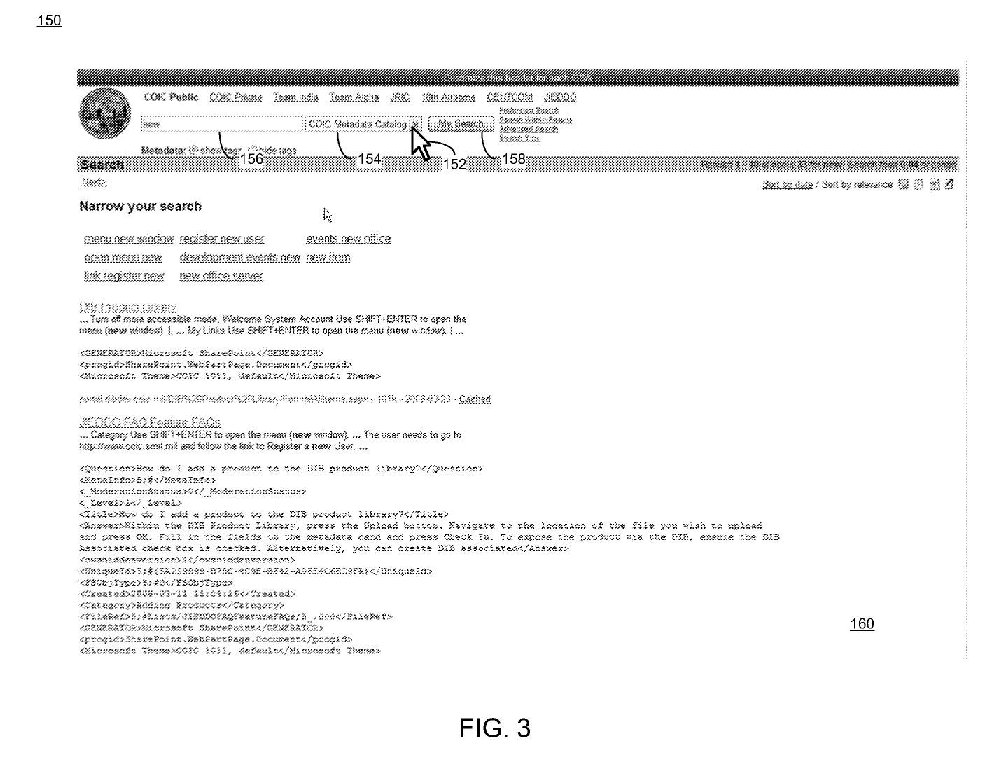

Searching 102 the one or more of the intelligence data stores may include searching 112 the metadata catalog. For example, and referring also to FIG. 3, one or more of content management application 52, database application 56, metadata framework application 60 and search device 68 may render search display screen 150. A user (e.g., user 48) may select, e.g., via onscreen pointer 152 controlled by a pointing device (e.g., a mouse, not shown) to search metadata catalog 76 from search option dropdown menu 154. Upon selecting to search metadata catalog 76, user 48 may input a desired search term in search field 156 and select, via onscreen pointer 152, search button 158, resulting in database application 56 (alone or in combination with one or more of content management application 52, metadata framework application 60, and/or search device 68) searching 112 metadata catalog 76 relative to the input search term. A search results set may be returned in results frame 160.

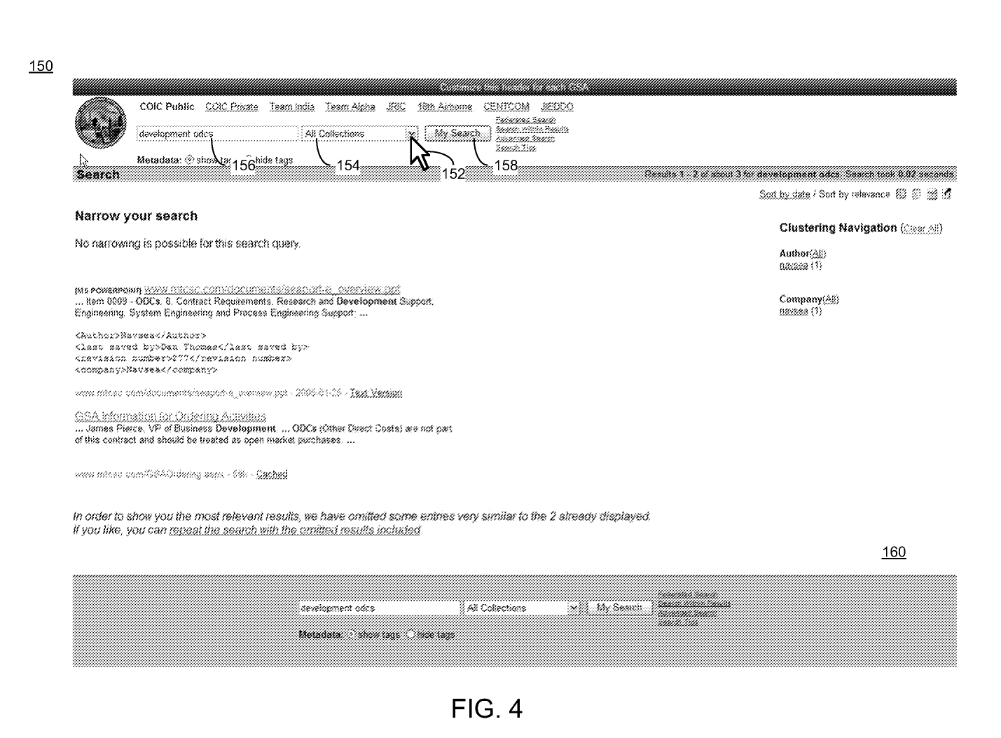

Referring also to FIG. 4, in addition to searching 114 metadata catalog 76, one or more of content management application 52, database application 56, metadata framework application 60 and search device 68 may allow user 48 to search 102 the entirety of intelligence data stores 28, 32, e.g., including unstructured data. For example, similar to as described above, user 48 may select, via onscreen pointer 152, “All Collections” from search option dropdown menu 154. Additionally, user 48 may input a desired search term in search field 156 and select, via onscreen pointer 152, search button 158, resulting, e.g., in search device 68 (alone or in combination with one or more of content management application 52, database application 56, and/or metadata framework application 60) searching 102 intelligence data stores 28, 32 relative to the input search term (e.g., by searching 102 search index 72). A search results set may be returned in results frame 160.

Managing 104, e.g., via content management application 52, at least a portion of the content of the one or more intelligence data stores (e.g., intelligence data stores 28, 32) may include one or more of creating content, modifying content, and deleting content 116. For example, a user (e.g., user 48) may create a new intelligence document to be stored in one or more of intelligence data stores 28, 32. Further, managing 104 at least a portion of the content of the one or more intelligence data stores (e.g., intelligence data stores 28, 32) may include generating 118 metadata associated with at least a portion of the content of the one or more intelligence data stores. For example, as discussed previously, while creating, modifying, and/or deleting content (e.g., intelligence data) content management application 52 may prompt a user (e.g., user 48) to input information which may be associated with the content. Content management application 52 may prompt user 48 to provide specific information relative to the content, such as geospatial information, names, dates descriptive locations, etc. Additionally/alternatively, content management application 52 may prompt user 48 to provide general and/or free form information. Information provided by user may result in content management application 52 (alone or in conjunction with metadata framework application 60) generating 118 metadata associated with the content.

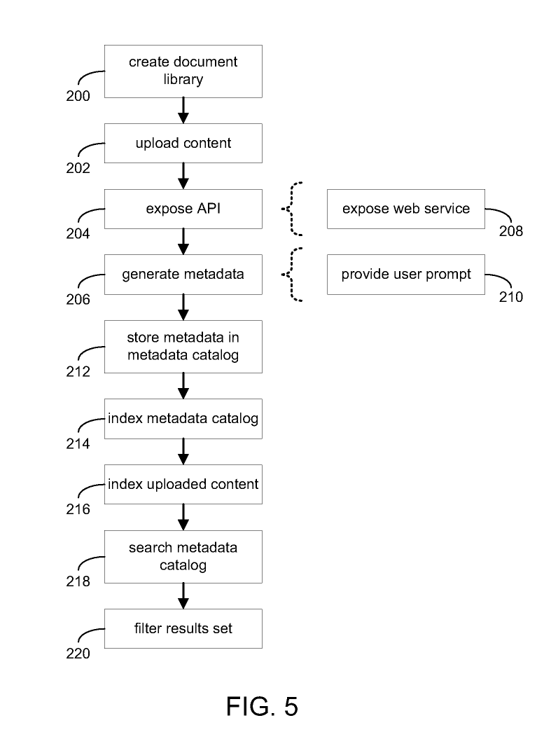

Referring also to FIG. 5, and continuing with the above-stated example, content management application 52 (alone or in combination with one or more of database application 56, metadata framework application 60, and search device 68) may create 200 a document library. The document library may reside, for example, on one or more of storage devices 36, 40 (e.g., included in one or more of intelligence data stores 28, 32) accessible via network 20. Content may be uploaded 202 to the document library, e.g., to be stored in one or more of intelligence data stores 28. The document library may include an unstructured data store. Additionally/alternatively, the document library may include a structured data store, e.g., a relational database provided by, e.g., database server application 44.

When content is uploaded 202, an application programming interface (API) may be exposed 204, allowing a metadata framework application (e.g., metadata framework application 60) to generate 206 metadata associated with the content being uploaded 202. The application programming interface (API) may be exposed 208 as a web service. For example, the content management application (e.g., content management application 52) may issue a web services call to metadata framework application 60. In response to the web services call, metadata framework application 60 may generate metadata associated with the uploaded content based upon, at least in part, a defined XML schema.

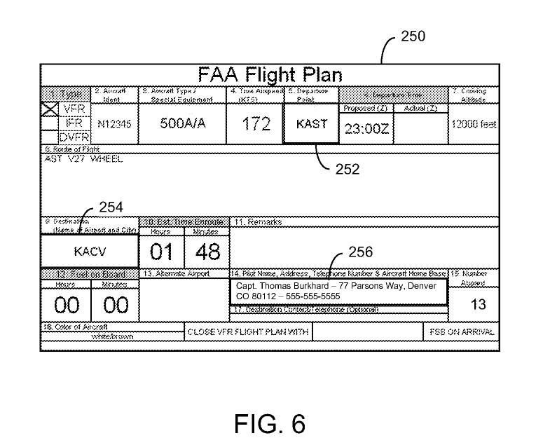

One or more XML schema files may be stored, e.g., on storage device 64. The one or more XML schema files may be defined for various intelligence data that may be uploaded 202 into one or more of the intelligence data stores (e.g., intelligence data stores 28, 32). For example, and referring also to FIG. 6, user 48 may upload 202 a flight plan 250 via content management application 52. Flight plan 250 may include various field, e.g., departure point 252, destination 254, pilot name 256, as well as various other information. An XML schema file defined for flight plan intelligence data may define the elements of flight plan 25. Metadata framework application 60 may generate 206 metadata associated with flight plan 250, based upon, at least in part, the knowledge of the placement of elements of a flight plan defined by the XML schema file.

In addition/as an alternative to metadata generated by metadata framework application 60, content management application 52 (alone, or in combination with one or more of database application 56, metadata framework application 60, and search device 68) may provide 210 a prompt to user 48 to provide user generated metadata. As discussed above, the provided 210 user prompt for metadata may include a prompt to provide specific information relating to the intelligence data being uploaded 202. Additionally/alternatively, the provided 210 user prompt may allow the user to provide free-form information to be associated with the intelligence data.

Generated 206 metadata may be stored 212 in a metadata catalog (e.g., metadata catalog 76). For example, the metadata generated 206 by metadata framework application 60, e.g., in response to the web services call from content management application 52, may be stored 212 in metadata catalog 76 by database application 56. Metadata catalog 76 may include a relational database, e.g., which may be queried via database application 56.

Search device 68 may index 214 the metadata catalog (e.g., metadata catalog 76). For example, search device 68 may crawl metadata catalog 76. The returned results may be stored in search index 72. Additionally, alternatively, the document library (e.g., which may reside in one or more of intelligence data store 28, 32) may be indexed 216. As such, the uploaded 202 content may be indexed 216 by search device 68.

The metadata catalog (e.g., metadata catalog 76) and/or the search index (e.g., search index 72) may be searched 218. For example, metadata catalog 76 may be searched by issuing a query to database application 56. In such an embodiment, a user (e.g., user 48) may issue a search request (e.g., directly to database application 56 and/or via search device 68). As a result of the search request, a query may be issued to database application 56. A search results set may be returned based upon, at least in part, the query issued to database application 56. Additionally/alternatively, a search request may be issued to search device 68, e.g., which may return a results set based upon information contained within search index 72.

One or more of database application 56 and/or search device 68 may allow user 48 to filter 220 the results set. For example, user 48 may be allowed to filter the results set based upon the particular document library, intelligence data source, intelligence data attributes (e.g., intelligence data including imagery, pertaining to a particular geographic location, etc.), keywords, or the like.

In the above-described implementation, user 48 has been described uploading 202 and searching 218 intelligence data residing in a local intelligence data store (e.g., one or more of intelligence data stores 28, 32 coupled to network 20, which may be a local area network) associated with node 10. In a similar manner, a remote user (e.g., user 50) may upload content to either a remote intelligence data store and/or may search for intelligence data residing in a remote intelligence data store (e.g., intelligence data stores 28, 32 being remote relative to user 50), and/or searching both remote and local intelligence data stores (e.g., intelligence data stores 28, 32 and 30, 34, respectively). For example, user 50 may search for intelligence data, e.g., by issuing a search request via search device 70. Search device 70 may execute the search relative to local intelligence data stores (e.g., intelligence data stores 30, 34), e.g., by searching metadata catalog 78 and/or search index 74. Additionally, user 50 may search intelligence data residing in remote intelligence data stores (e.g., intelligence data stores 28, 32), e.g., by search device 70 additionally/alternatively searching metadata catalog 76 and/or search index 72. Search device 70 may search metadata catalog 76 and/or search index 72 directly and/or by issuing a search request to one or more of database application 56 and/or search device 68. Further, search device 70 may index search index 72, e.g., utilizing HTTP methodologies.

As such, a user associated with one node (e.g., user 50 associated with node 12) may search intelligence data residing on intelligence data stores associated with a remote node (e.g., intelligence data stores 28, 32 associated with node 10) on a different network (e.g., network 20). In addition to being remote, and/or residing on different networks, nodes 10 and 12, and associated intelligence data stores 28, 32 and 30, 34, respectively, may be under the control of different intelligence agencies. Further, the data structures of intelligence data stores 28, 32 and 30, 34 may differ from one another. Nodes 10, 12 and associated metadata catalogs 76, 68 and search device 68, 70 may provide data level interoperability, which may allow users associated with one intelligence agency to search the intelligence data of other intelligence agencies.

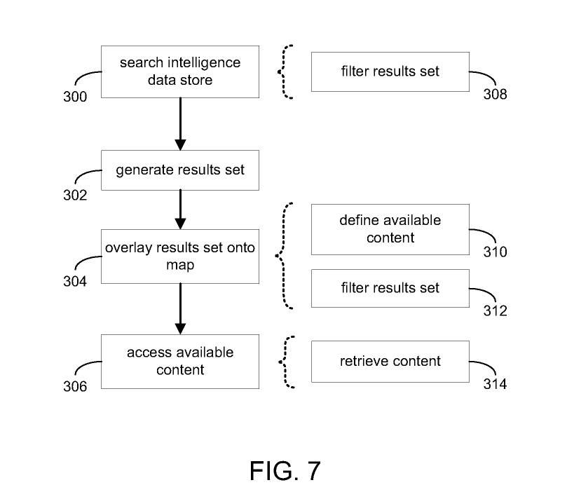

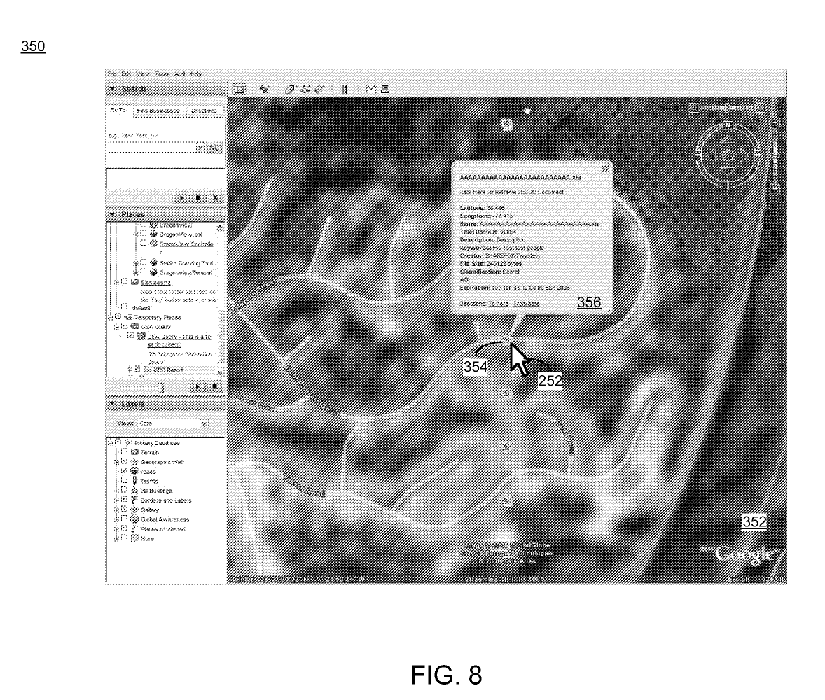

Referring also to FIG. 7, one or more intelligence data store may be searched 300, e.g., as described herein-above, to generate 302 a results set. At least a portion of the results set may be overlaid 304 onto a graphical map. A user may access 306 available content. For example, and referring also to FIG. 8, a user (e.g., user 50) may utilize a geospatial application (e.g., geospatial application 84, executed by computing device 26). Examples of geospatial application 84 may include, but is not limited to, Google Earth™, or other geospatial or mapping application. Geospatial application 84 may provide display screen 350. Via geospatial application 84, user 50 may select a specific geographic location (e.g., which may include a precise location, a general region, etc.). Geospatial application 84 may render map 352, satellite imagery, or the like, of the selected geographic location.

Upon selecting the specific geographic location, geospatial application 84 may issue a search request to one or more of database application 58, metadata framework application 62, and/or search device 70 relative to the selected geographic location. Responsive to the search request, a search may be executed on one or more intelligence data store (e.g., intelligence data stores 28, 30, 32, 34, which may include structured and/or unstructured intelligence data), one or more search index (e.g., search index 72, 74), and/or one or more metadata catalogs (e.g., metadata catalogs 76, 78). For example, geospatial application 84 may issue a search request to search device 70, e.g., which may search 300 search index 74 (e.g., a proxy for a search of intelligence data stores 28, 30, 32, 34, as well as metadata catalogs 76, 78) relative to the selected geographic location and generate 302 a results set relevant to the selected geographic location.

Geospatial application 84 may overlay 304 at least a portion of the generated 302 results set onto map 352. For example, as shown, the at least a portion of the results set may be displayed on map 352 as icons (e.g., icon 354) on map 352. The icons (e.g., icon 354) may be positioned on map 352 based upon, at least in part, geospatial metadata associated with various pieces of content (e.g., intelligence data), for example, in terms of relative position, latitude-longitude coordinates, or military grid coordinate system coordinates. As such, geospatial application 84, in conjunction with node 12, may define 308 available content (e.g., intelligence data) relative to the selected geographic location based upon, at least in part, geospatial metadata associated with one or more pieces of content (e.g., intelligence data) residing in one or more intelligence data store.

Searching 250 the one or more intelligence data stores may include filtering 310 the results set based upon one or more user defined filtering parameters. In addition to defining a selected geographic location, a user may provide other search criteria, e.g., which may filter the generated 302 search results set. For example, user 50 may define IED (improvised explosive device) as a searching criteria. According, the one or more intelligence data stores may be searched 300 relative to the selected geographic location and relative to the keyword(s) “IED” and/or “improvised explosive device.”

Similarly, overlaying 304 at least a portion of the results set onto the graphical map (e.g., map 352) may include filtering 312 the results set. Filtering 312 the results set may include filtering 312 the results set based upon, at least in part, geographical information. For example, after selecting a first geographic location, geospatial application 84 may issue a search request and may overlay 304 at least a portion of the generated 302 search results set onto map 352. User 50 may further zoom in on a particular portion of map 352. Geospatial application 84 may filter 312 the results set based upon, at least in part, geographical information corresponding to the portion of map 352 displayed after zooming.

Accessing 306 the one or more available pieces of content may include retrieving 314 the one or more pieces of content from the one or more intelligence data stores (e.g., intelligence data stores 28, 30, 32, 34). As shown, geospatial application 84 (alone or in conjunction with node 12) may provide summary 356 various pieces of available content, e.g., in response to user 50 hovering onscreen pointer 252 over an icon (e.g., icon 354) on map 352. Summary 356 may be based upon, at least in part, metadata associated with the intelligence data indicated by icon 354. User 50 may select, e.g., using onscreen pointer 252, icon 354 to retrieve 314 the entirety of the intelligence data indicated by icon 354. The retrieved 314 content (e.g., intelligence data) may be rendered via an appropriate application (e.g., word processing application, spread sheet application, image viewer) depending upon the format and nature of the content.

While various embodiments and implementations have been shown and described, it should be understood that the foregoing description is intended for illustrative purposes only, as numerous variations and modifications are possible. As such, the invention should be afforded the full scope of the claims appended hereto.

What is claimed is:

1. A system comprising:
one or more server computing devices coupled to a data network;
one or more storage devices associated with each of the one or more server computing devices; and
a search device configured to search intelligence data residing on one or more of the storage devices.

2. The system of claim 1, wherein the search device is configured to index at least a portion of the intelligence data residing on one or more of the storage devices.

3. The system of claim 1, wherein the intelligence data includes unstructured intelligence data.

4. The system of claim 1, wherein the intelligence data includes structured intelligence data.

5. The system of claim 4, wherein the structured intelligence data resides in one or more intelligence databases on one or more of the storage devices.

6. The system of claim 1, wherein the intelligence data includes metadata associated with one or more intelligence documents.

7. The system of claim 6, wherein the metadata associated with one or more intelligence documents resides in a metadata catalog stored on one or more of the storage devices.

8. The system of claim 1, further including a content management system for creating a document library, wherein at least a portion of the intelligence data residing on the one or more storage devices is included within the document library.

9. A system comprising:
a first server computing device coupled to a first data network, the first server computing device including one or more storage devices including intelligence data;
a first node platform coupled to the first data network and coupled to a second data network, the first node platform including a first search device configured to search the intelligence data residing on one or more of the storage devices.

10. The system of claim 9, wherein the first search device is configured to index at least a portion of the intelligence data of the first server computing device.

11. The system of claim 9, wherein the intelligence data of the first server computing device includes unstructured data.

12. The system of claim 9, wherein the intelligence data of the first server computing device includes structured data.

13. The system of claim 12, wherein the structured data resides in a database on the one or more storage devices.

14. The system of claim 9, further including a second node platform coupled to the second data network, the second node platform including a second search device configured to search the intelligence data of the first server computing device.

15. The system of claim 14, wherein the second search device is configured to search an index of the intelligence data created by the first search device.

16. The system of claim 14, wherein the second search device is configured to search a metadata catalog including metadata associated with the intelligence data.

17. The system of claim 16, wherein the metadata catalog is associated with the first node.
